(19) United States
(12) Patent Application Publication
(10) Pub. No.: US 2022/0356397 A1
(43) Pub. Date: Nov. 10, 2022

(54) DOPED INORGANIC COMPOSITIONS FOR RADIATION AND NUCLEAR THREAT DETECTION

(71) Applicant: Corning Incorporated, Corning, NY (US)

(72) Inventor: Matthew John Dejneka, Corning, NY (US)

(21) Appl. No.: 17/691,620

(22) Filed: Mar. 10, 2022

Related U.S. Application Data
(60) Provisional application No. 63/164,142, filed on Mar. 22, 2021.

(51) Int. Cl. C09K 11/77; G01T 3/06

(52) U.S. Cl. CPC C09K 11/77064; C09K 11/7705; G01T 3/06

(57) ABSTRACT

An optical material includes, in mol.%: 50-75% SiO₂, 5-25% Al₂O₃, 2.5-25% MgO, and 1-15% at least one lanthanoid, such that the at least one lanthanoid includes: La, Ce, Pr, Nd, Pm, Sm, Eu, Gd, Tb, Dy, Ho, Er, Tm, Yb, Lu, or oxides or fluorides thereof. An optical material includes at least one lanthanoid and at least one alkaline earth fluoride dopant, such that the at least one lanthanoid includes: La, Ce, Pr, Nd, Pm, Sm, Eu, Gd, Tb, Dy, Ho, Er, Tm, Yb, Lu, or oxides or fluorides thereof, and such that the at least one alkaline earth fluoride dopant comprises BeF₂, MgF₂, CaF₂, SrF₂, and BaF₂.

### CROSS-REFERENCE TO RELATED APPLICATIONS

This application claims the benefit of priority under 35 U.S.C. § 120 of U.S. Application Ser. No. 63/164,142, filed on Mar. 22, 2021, the content of which is relied upon and incorporated herein by reference in its entirety.

### BACKGROUND

### 1. Field

The disclosure relates to doped inorganic compositions for radiation and nuclear threat detection.

### 2. Technical Background

Due to the difficulty in direct neutron detection, scintillators are often utilized to first absorb thermalized (slowed) neutrons and then emit visible light which is detected using silicon (Si) photodiodes or photomultiplier tubes.

This disclosure presents improved inorganic compositions for scintillators used in radiation and nuclear threat detection.

### SUMMARY

In some embodiments, an optical material, comprising, in mol.%: 50-75% SiO₂, 5-25% Al₂O₃, 2.5-25% MgO, and 1-15% at least one lanthanoid, wherein the at least one lanthanoid includes: La, Ce, Pr, Nd, Pm, Sm, Eu, Gd, Tb, Dy, Ho, Er, Tm, Yb, Lu, or oxides, or fluorides thereof.

In one aspect, which is combinable with any of the other aspects or embodiments, the optical material comprises, in mol.%: 60-70% SiO₂, 9-21% Al₂O₃, and 5-20% MgO. In one aspect, which is combinable with any of the other aspects or embodiments, the at least one lanthanoid comprises Gd2O₃. In one aspect, which is combinable with any of the other aspects or embodiments, the optical material has a Gd ion concentration of 1.5×10²¹ Gd³⁺ ions/cc. In one aspect, which is combinable with any of the other aspects or embodiments, the optical material has a refractive index of less than 1.6. In one aspect, which is combinable with any of the other aspects or embodiments, the optical material has a transmission of greater than 85% for 435 nm light when the optical material is 1 mm thick. In one aspect, which is combinable with any of the other aspects or embodiments, the optical material further comprises a dopant selected from Ce³⁺, Eu²⁺, Eu³⁺, and Tb³⁺. In one aspect, which is combinable with any of the other aspects or embodiments, a neutron detector comprises a scintillating material including an optical material described herein.

In some embodiments, an optical material, comprises: at least one lanthanoid and at least one alkaline earth fluoride dopant, wherein the at least one lanthanoid includes: La, Ce, Pr, Nd, Pm, Sm, Eu, Gd, Tb, Dy, Ho, Er, Tm, Yb, Lu, or oxides, or fluorides thereof, and wherein the at least one alkaline earth fluoride dopant comprises BeF₂, MgF₂, CaF₂, SrF₂, and BaF₂.

In one aspect, which is combinable with any of the other aspects or embodiments, the at least one lanthanoid comprises GdF₃. In one aspect, which is combinable with any of the other aspects or embodiments, the optical material has a Gd ion concentration of 3×10²¹ Gd³⁺ ions/cc. In one aspect, which is combinable with any of the other aspects or embodiments, the optical material has a refractive index of less than 1.6. In one aspect, which is combinable with any of the other aspects or embodiments, the optical material has a transmission of greater than 85% for 435 nm light when the optical material is 1 mm thick. In one aspect, which is combinable with any of the other aspects or embodiments, the optical material further comprises a dopant selected from Ce³⁺, Eu²⁺, Eu³⁺, and Tb³⁺. In one aspect, which is combinable with any of the other aspects or embodiments, a neutron detector comprises a scintillating material including the optical material described herein.

In some embodiments, an optical material comprises 51 to 79 mole% SiO₂, 0 to 25 mole% Al₂O₃, and 2 to 10 mole% Gd₂O₃, wherein the optical material has a refractive index between 1.56 and 1.60 for 589.3 nm light.

### BRIEF DESCRIPTION OF THE DRAWINGS

The disclosure will become more fully understood from the following detailed description, taken in conjunction with the accompanying figures, in which:

FIG. 1 illustrates refractive indices of glasses containing Gd versus quantities of Gd₂O₃ included in the glass composition, according to some embodiments.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. When a numerical value or end-point of a range does not recite “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. It is noted that the terms “substantially” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass that is “free” or “essentially free” of Al₂O₃ is one in which Al₂O₃ is not actively added or batched into the glass, but may be present in very small amounts as a contaminant (e.g., 500, 400, 300, 200, or 100 parts per million (ppm) or less or).

Herein, glass compositions are expressed in terms of mol.% amounts of particular components included therein on an oxide bases unless otherwise indicated. Any component having more than one oxidation state may be present in a glass composition in any oxidation state. However, concentrations of such component are expressed in terms of the oxide in which such component is at its lowest oxidation state unless otherwise indicated.

Optical materials with at least one lanthanoid (or oxides or fluorides thereof) and/or alkaline earth fluoride enables thermalization (i.e., slowing) of neutrons for neutron detection and neutron emitter functions. In other words, these types of doped glass compositions help in slowing down neutrons for detection, as well as adjusting refractive index of the material to match with other components of the scintillator. Thus, inclusion of these dopants into glasses and crystals optimizes the materials to match indices with other scintillating materials of the device to enable neutron detection.

### Compositions

In some examples, the glass comprises a combination of SiO₂, Al₂O₃, MgO, and at least one lanthanoid (e.g., La, Ce, Pr, Nd, Pm, Sm, Eu, Gd, Tb, Dy, Ho, Er, Tm, Yb, Lu, or oxides, or fluorides thereof). For example, the glass may comprise a composition including, in mol.%: 50-75% SiO₂, 5-25% Al₂O₃, 2.5-25% MgO, and balance lanthanoid. In some examples, the glass may comprise a composition including, in mol.%: 50-75% SiO₂, 15-25% Al₂O₃, 2.5-25% MgO, and 1-15% lanthanoid. The silicate glasses disclosed herein are particularly suitable for neutron detection and neutron emitter functions.

Silicon dioxide (SiO₂), which serves as the primary glass-forming oxide component of the embodied glasses, may be included to provide high temperature stability and chemical durability. In some embodiments, the glass can comprise 50-75 mol.% SiO₂. In some examples, the glass can comprise 51 to 79 mole% SiO₂. In some examples, the glass may comprise 60-75 mol.% SiO₂. In some examples, the glass can comprise 50-75 mol.%, or 55-75 mol.%, or 55-70 mol.%, or 60-70 mol.% SiO₂, or any value or range disclosed therein. In some examples, the glass comprises 50, 51, 52, 53, 54, 55, 56, 57, 58, 59, 60, 61, 62, 63, 64, 65, 66, 67, 68, 69, 70, 71, 72, 73, 74, or 75 mol.% SiO₂, or any value or range having endpoints disclosed herein.

In some examples, the glasses comprise MgO. Alkaline earth oxides influence critical properties of glass materials, such as Young's modulus, coefficient of thermal expansion, melting behavior, and chemical durability. In some examples, the glass can comprise 2.5-25 mol.% MgO. In some examples, the glass can comprise 5-20 mol.% MgO. In some examples, the glass can comprise from 0-25 mol.%, or >0-25 mol.%, or 2.5-25 mol.%, or 2.5-22.5 mol.%, or 5-22.5 mol.%, or 5-20 mol.%, or 7.5-20 mol.%, or 7.5-17.5 mol.%, or 10-17.5 mol.%, or 10-15 mol.% MgO, or any value or range disclosed therein. In some examples, the glass can comprise 2.5, 3, 4, 5, 6, 7, 8, 9, 10, 11, 12, 13, 14, 15, 16, 17, 18, 19, 20, 21, 22, 23, 24, or 25 mol.% MgO, or any value or range having endpoints disclosed herein. In some examples, the glass may be essentially free of MgO.

Alumina (Al₂O₃) serves to function as a network former or intermediate in precursor glasses, as well as a key oxide for improving glass thermal stability by significantly reducing glass devitrification during forming. Additionally, alumina may also help to lower liquidus temperature and coefficient of thermal expansion or enhance the strain point. In addition to its role as a network former, Al₂O₃ also helps improve chemical durability and mechanical properties in silicate glass. In some examples, the glass can comprise 5-25 mol.% Al₂O₃. In some examples, the glass can comprise 0 to 25 mole% Al₂O_{3.} In some examples, the glass can comprise from 0-25 mol.%, or >0-25 mol.%, or 5-25 mol.%, 7-25 mol.%, 7-23 mol.%, 9-23 mol.%, 9-21 mol.%, 11-21 mol.%, 11-19 mol.%, 13-19 mol.%, 13-17 mol.% Al₂O₃, or any value or range disclosed therein. In some examples, the glass can comprise 5, 6, 7, 8, 9, 10, 11, 12, 13, 14, 15, 16, 17, 18, 19, 20, 21, 22, 23, 24 or 25 mol.% Al₂O₃, or any value or range having endpoints disclosed herein. In some examples, the glass may be essentially free of Al₂O₃.

At least one lanthanoid (e.g., La, Ce, Pr, Nd, Pm, Sm, Eu, Gd, Tb, Dy, Ho, Er, Tm, Yb, Lu, or oxides, or fluorides thereof) may also be included in the glass composition. As stated above, each may help in slowing down neutrons for detection, as well as adjusting refractive index of the material to match with other components of the scintillator. In some examples, the glass can comprise 1-15 mol.% lanthanoid. In some examples, the glass can comprise 2 to 10 mole% Gd₂O₃. In some examples, the glass can comprise from 1-15 mol.%, 2-15 mol.%, 2-14 mol.%, 3-14 mol.%, 3-13 mol.%, 4-13 mol.%, 4-12 mol.%, 5-12 mol.%, 5-11 mol.% lanthanoid, or any value or range disclosed therein. In some examples, the glass can comprise 1, 2, 3, 4, 5, 6, 7, 8, 9, 10, 11, 12, 13, 14, or 15 mol.% lanthanoid, or any value or range having endpoints disclosed herein.

In some embodiments, a crystal composition may comprise at least one lanthanoid (e.g., La, Ce, Pr, Nd, Pm, Sm, Eu, Gd, Tb, Dy, Ho, Er, Tm, Yb, Lu, or oxides, or fluorides thereof) doped with alkaline earth fluoride (e.g., BeF₂, MgF₂, CaF₂, SrF₂, BaF₂) to achieve similar refractive index effects.

Additional components can be incorporated into the glass to provide additional benefits or may be incorporated as contaminants typically found in commercially-prepared glass. For example, additional components can be added as coloring or fining agents (e.g., to facilitate removal of gaseous inclusions from melted batch materials used to produce the glass) and/or for other purposes. In some examples, the glass may comprise one or more compounds useful as ultraviolet radiation absorbers. In some examples, the glass can comprise suitable quantities of ZrO₂, at least one alkali metal oxide (e.g., Li₂O, Na₂O, K₂O, Rb₂O, or Cs₂O), at least one alkaline earth metal oxide (BeO, MgO, CaO, SrO, BaO), or B₂O₃, etc. In some examples, the glass can comprise 3 mol.% or less ZnO, TiO₂, CeO, MnO, Nb₂O₅, MoO₃, Ta₂O₅, WO₃, SnO₂, Fe₂O₃, As₂O₃, Sb₂O₃, Cl, Br, or combinations thereof. In some examples, the glass can comprise from 0 to about 3 mol.%, 0 to about 2 mol.%, 0 to about 1 mol.%, 0 to 0.5 mol.%, 0 to 0.1 mol.%, 0 to 0.05 mol.%, or 0 to 0.01 mol.% ZnO, TiO₂, CeO, MnO, Nb₂O₅, MoO₃, Ta₂O₅, WO₃, SnO₂, Fe₂O₃, As₂O₃, Sb₂O₃, Cl, Br, or combinations thereof. The glasses, according to some examples, can also include various contaminants associated with batch materials and/or introduced into the glass by the melting, fining, and/or forming equipment used to produce the glass. For example, in some embodiments, the glass can comprise from 0 to about 3 mol.%, 0 to about 2 mol.%, 0 to about 1 mol.%, 0 to about 0.5 mol.%, 0 to about 0.1 mol.%, 0 to about 0.05 mol.%, or 0 to about 0.01 mol.% SnO₂ or Fe₂O₃, or combinations thereof.

### EXAMPLES

The embodiments described herein will be further clarified by the following examples.

Non-limiting examples of amounts of precursor oxides for forming the embodied glasses are listed in Table 1, along with the properties of the resulting glasses. The refractive index may be measured at 435 nm using a Metricon Model 2010 Prism Coupler. Measurements were made at 425, 486.13, 589.30, and 656.27 nm and fitted with Sellmeier coefficients to interpolate the index at 435 nm. Example 4 is extrapolated to achieve the 1.595 nm target index.

TABLE 1

| Oxide (mol.%) | 1 | 2 | 3 | 4 |
|---|---|---|---|---|
| SiO₂ | 68 | 67 | 66 | 63.145 |
| Al₂O₃ | 16.2 | 15.42 | 14.64 | 11.785 |
| MgO | 6 | 9 | 12 | 20.565 |
| Gd₂O₃ | 9.8 | 8.58 | 7.36 | 3.8769 |
| Refractive Index, n | 1.628 | 1.623 | 1.614 | 1.595 |

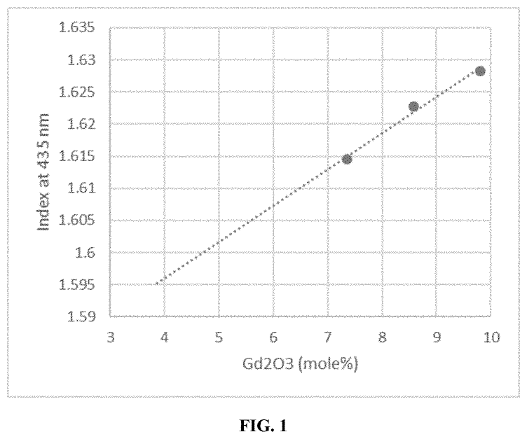

FIG. 1 illustrates refractive indices of Examples 1-3 from Table 1 as a function of Gd₂O₃ concentration. Example 4 from Table 1 indicates that at concentrations of about 3.9 mol.% Gd₂O₃ (or equivalently, 16 wt.% Gd₂O₃), a target refractive index of 1.595 may be achieved.

For crystal composition may comprising GdF₃, alkaline earth fluoride dopants may be added to the crystal to achieve the desired 1.595 target refractive index. For example, it was determined that while a GdF₃ crystal has a refractive index exceeding 1.6, inclusion of 10 mol.% CaF₂ or 12 mol.% SrF₂ dopant decreases the final index to about 1.595. By this means, a high concentration of Gd³⁺ ions/cc in the crystal is observed, while still achieving the target index of refraction.

The glass and crystal composition disclosed herein exhibit enhanced performance as materials for scintillators used in radiation and nuclear threat detection. The compositions can be in the form of, for example, particles, powder, microspheres, fibers, sheets, beads, scaffolds, woven fibers, or other form depending on the application.

### Glass Making Processes

Glasses having the oxide contents listed in Table 1 can be made via traditional methods. For example, in some examples, the precursor glasses can be formed by thoroughly mixing the requisite batch materials (for example, using a turbula mixer) in order to secure a homogeneous melt, and subsequently placing into silica and/or platinum crucibles. The crucibles can be placed into a furnace and the glass batch melted and maintained at temperatures ranging from 1200° C. to 1650° C. for times ranging from about 2 hours to 24 hours. The melts can thereafter be poured into steel molds to yield glass slabs. Subsequently, those slabs can be transferred immediately to an annealer operating at about 400° C. to 900° C., where the glass is held at temperature for about 0.5 hour to 3 hours and subsequently cooled overnight. In another non-limiting example, precursor glasses are prepared by dry blending the appropriate oxides and mineral sources for a time sufficient to thoroughly mix the ingredients. The glasses are melted in platinum crucibles at temperatures ranging from about 1200° C. to 1650° C. and held at temperature for about 2 hours to 16 hours. The resulting glass melts are then poured onto a steel table to cool. The precursor glasses are then annealed at appropriate temperatures.

The embodied glass compositions can be ground into fine particles in the range of 1-10 microns (μm) by air jet milling. The particle size can be varied in the range of 1-100 μm using attrition milling or ball milling of glass frits. Furthermore, these glasses can be processed into short fibers, beads, sheets or three-dimensional scaffolds using different methods. Short fibers are made by melt spinning or electric spinning; beads can be produced by flowing glass particles through a hot vertical furnace or a flame torch; sheets can be manufactured using thin rolling, float or fusion-draw processes; and scaffolds can be produced using rapid prototyping, polymer foam replication and particle sintering.

Continuous fibers can be easily drawn from the disclosed composition using processes known in the art. For example, fibers can be formed using a directly heated (electricity passing directly through) platinum bushing. Glass cullet is loaded into the bushing, heated up until the glass can melt. Temperatures are set to achieve a desired glass viscosity (usually <1000 poise) allowing a drip to form on the orifice in the bushing (Bushing size is selected to create a restriction that influences possible fiber diameter ranges). The drip is pulled by hand to begin forming a fiber. Once a fiber is established it is connected to a rotating pulling/collection drum to continue the pulling process at a consistent speed. Using the drum speed (or revolutions per minute RPM) and glass viscosity the fiber diameter can be manipulated — in general the faster the pull speed, the smaller the fiber diameter. Glass fibers with diameters in the range of 1-100 μm can be drawn continuously from a glass melt. Fibers can also be created using an updraw process. In this process, fibers are pulled from a glass melt surface sitting in a box furnace. By controlling the viscosity of the glass, a quartz rod is used to pull glass from the melt surface to form a fiber. The fiber can be continuously pulled upward to increase the fiber length. The velocity that the rod is pulled up determines the fiber thickness along with the viscosity of the glass. Fibers can greatly increase the strength and toughness of the composite (as is well known in the field of fiberglass reinforced composites) while still providing thermalization and scintillation.

Thus, as presented herein, improved inorganic compositions for scintillators used in radiation and nuclear threat detection are described.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

References herein to the positions of elements (e.g., “top,” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Unless otherwise specified, all compositions are expressed in terms of as-batched mole percent (mol.%). As will be understood by those having ordinary skill in the art, various melt constituents (e.g., silicon, alkali- or alkaline-based, boron, etc.) may be subject to different levels of volatilization (e.g., as a function of vapor pressure, melt time and/or melt temperature) during melting of the constituents. As such, the as-batched weight percent values used in relation to such constituents are intended to encompass values within ±0.5 wt.% of these constituents in final, as-melted articles. With the forgoing in mind, substantial compositional equivalence between final articles and as-batched compositions is expected.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. An optical material, comprising, in mol.%:
50-75% SiO₂,
5-25% Al₂O₃,
2.5-25% MgO, and
1-15% at least one lanthanoid,
wherein the at least one lanthanoid includes: La, Ce, Pr, Nd, Pm, Sm, Eu, Gd, Tb, Dy, Ho, Er, Tm, Yb, Lu, or oxides, or fluorides thereof.

2. The optical material of claim 1, comprising, in mol.%:
60-70% SiO₂,
9-21% Al₂O₃, and
5-20% MgO.

3. The optical material of claim 1, wherein the at least one lanthanoid comprises Gd₂O_{3.}

4. The optical material of claim 3, having a Gd ion concentration of 1.5×10²¹ Gd³⁺ ions/cc.

5. The optical material of claim 1, having a refractive index of less than 1.6.

6. The optical material of claim 1, having a transmission of greater than 85% for 435 nm light when the optical material is 1 mm thick.

7. The optical material of claim 1, further comprising: a dopant selected from Ce³⁺, Eu²⁺, Eu³⁺, and Tb³⁺.

8. A neutron detector comprising a scintillating material including the optical material of claim 1.

9. An optical material, comprising:
at least one lanthanoid and at least one alkaline earth fluoride dopant,
wherein the at least one lanthanoid includes: La, Ce, Pr, Nd, Pm, Sm, Eu, Gd, Tb, Dy, Ho, Er, Tm, Yb, Lu, or oxides, or fluorides thereof, and
wherein the at least one alkaline earth fluoride dopant comprises BeF₂, MgF₂, CaF₂, SrF₂, and BaF₂.

10. The optical material of claim 9, wherein the at least one lanthanoid comprises GdF₃.

11. The optical material of claim 10, having a Gd ion concentration of 3×10²¹ Gd³⁺ ions/cc.

12. The optical material of claim 9, having a refractive index of less than 1.6.

13. The optical material of claim 9, having a transmission of greater than 85% for 435 nm light when the optical material is 1 mm thick.

14. The optical material of claim 9, further comprising: a dopant selected from Ce³⁺, Eu²⁺, Eu³⁺, and Tb³⁺.

15. A neutron detector comprising a scintillating material including the optical material of claim 9.

16. An optical material, comprising:
51 to 79 mole% SiO₂,
0 to 25 mole% Al₂O₃, and
2 to 10 mole% Gd₂O₃,
wherein the optical material has a refractive index between 1.56 and 1.60 for 589.3 nm light.
